(19) United States
(12) Patent Application Publication
(10) Pub. No.: US 2015/0074599 A1
(43) Pub. Date: Mar. 12, 2015

(54) MOBILE VIDEO CHANNEL-BASED GESTURAL USER INTERFACE

(71) Applicant: Yahoo! Inc., Sunnyvale, CA (US)

(72) Inventors: Robert Stein, New York, NY (US); Anthony Cafaro, New York, NY (US); Bart Stein, New York, NY (US)

(21) Appl. No.: 14/020,693

(22) Filed: Sep. 6, 2013

(51) Int. Cl. G06F 3/0481; G06F 3/0482

(52) U.S. Cl. CPC G06F 3/04817; G06F 3/0482
USPC 715/810

(57) ABSTRACT

In one embodiment, a graphical user interface is provided, where the graphical user interface includes a plurality of rows, each of the plurality of rows corresponding to a different one of a plurality of information sources. Each of the plurality of rows may include a plurality of icons, each of the plurality of icons representing a different one of a plurality of content items available from the corresponding one of the plurality of information sources. Input may be received, where the input indicates at least one of a vertical navigation with respect to the plurality of rows or horizontal navigation with respect to the plurality of icons within one of the plurality of rows. The graphical user interface may be traversed or modified according to the input.

### BACKGROUND

The disclosed embodiments relate generally to methods and apparatus for navigating information sources and content items via a graphical user interface.

Individuals have access to a number of information resources via the Internet. As a result, individuals may access content that is published via the Internet using a number of web sites. Content that is accessible via the web sites may include digital media items, which may include text, audio, video, photographs, and/or other images. For example, digital media items may be accessed via a corresponding Uniform Resource Locator (URL).

A number of web sites provide search services. Through the use of these search services, users may search for media items that may be of interest to them.

### SUMMARY

The disclosed embodiments enable content to be navigated using a graphical user interface rendered via a device such as a mobile device. The content may include, but is not limited to, text, audio, video, photographs, and/or other images.

In accordance with one embodiment, a graphical user interface is provided, where the graphical user interface includes a plurality of rows, each of the plurality of rows corresponding to a different one of a plurality of information sources. Each of the plurality of rows may include a plurality of icons, each of the plurality of icons representing a different one of a plurality of content items available from the corresponding one of the plurality of information sources. Input may be received, where the input indicates at least one of a vertical navigation with respect to the plurality of rows or horizontal navigation with respect to the plurality of icons within one of the plurality of rows. The graphical user interface may be traversed or modified according to the input.

Various embodiments may be implemented via a device comprising a processor, memory, and a display. The processor and memory are configured to perform one or more of the above described method operations. Other embodiments may be implemented via a computer readable storage medium having computer program instructions stored thereon that are arranged to perform one or more of the above described method operations.

These and other features and advantages of the disclosed embodiments will be presented in more detail in the following specification and the accompanying figures which illustrate by way of example the principles of the disclosed embodiments.

### BRIEF DESCRIPTION OF THE DRAWINGS

FIG. 1 is a diagram illustrating an example system in which various embodiments may be implemented.

FIG. 2A is an example graphical user interface providing a gallery view in accordance with various embodiments.

FIG. 2B is an example graphical user interface providing a core watch view of a single content item in accordance with various embodiments.

FIG. 2C is an example graphical user interface providing a full screen view of a single content item in accordance with various embodiments.

FIG. 2D is a diagram illustrating a single content item rendered within the context of a grid in accordance with various embodiments.

FIG. 3A is an example graphical user interface for receiving search queries in accordance with various embodiments.

FIG. 3B is an example graphical user interface that may enable a user to navigate among search results in accordance with various embodiments.

FIG. 4 is an example graphical user interface that may be used to save a content item in accordance with various embodiments.

FIG. 5 is an example online content store via which the graphical user interface can be configured in accordance with various embodiments.

FIG. 6 is a process flow diagram illustrating an example method of navigating a graphical user interface in accordance with various embodiments.

FIG. 7 is a schematic diagram illustrating an example embodiment of a network in which various embodiments may be implemented.

FIG. 8 is a schematic diagram illustrating an example client device in which various embodiments may be implemented.

FIG. 9 is a schematic diagram illustrating an example computer system in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Content accessible via the Internet may be contained within an object, such as a Web object, web page, web site, electronic document, or the like. An item in a collection of content may be referred to as an “item of content” or a “content item,” and may be retrieved from a “Web of Objects” comprising objects made up of a variety of types of content. A collection of content such as a newspaper may include a plurality of content items. Each content item may include, for example, video, audio, text, a photograph, and/or other image.

The disclosed embodiments enable a graphical user interface to be rendered to a device such as a mobile device. Through the use of the graphical user interface, a user may easily navigate among different information sources, as well as content items available from those information sources. In addition, such a graphical user interface may be configurable, enabling the user to select those information sources and/or content items to be presented via the graphical user interface

### Example System

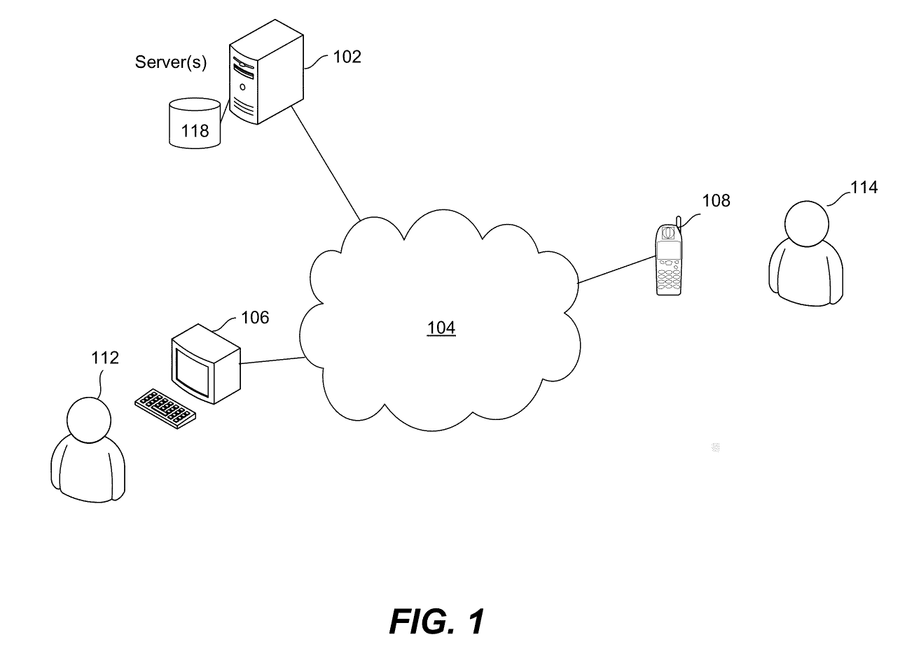

FIG. 1 is a diagram illustrating an example system in which various embodiments may be implemented. As shown in FIG. 1, the system may include one or more servers 102. In accordance with various embodiments, the servers 102 may be associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, users of the web site may perform activities such as access user accounts or public user profiles, interact with other members of the web site, transmit messages, upload content items (e.g., photographs, videos), purchase goods or services, access information such as content items posted on or otherwise available from the web site, or other information sources, as will be described in further detail below.

The server(s) 102 may support requests such as search requests that enable users to access content items provided via the web site. In addition, the server(s) 102 may enable users to access content items via a graphical user interface, as described herein. More particularly, a graphical user interface rendered via a device such as a mobile device may simplify access by a user to content items available from various information sources such as web sites or television channels. The content items available from the information sources may be maintained by the server(s) 102 in one or more data stores 118, which may include one or more memories. In some embodiments, content items may be provided directly from the information sources (e.g., via a feed from a content provider that is followed by the user).

In accordance with various embodiments, the information sources and/or content items that are accessible via a graphical user interface of a user device such as a mobile device are configurable. Such a configuration may be performed by establishing configuration preferences via the user device or another device. Alternatively, the configuration may be automatically generated based, at least in part, upon a user profile. In some instances, the configuration may be a default configuration.

The configuration may be associated with the user device (e.g., mobile device) via which the configuration preferences have been established, a particular user (e.g., the user who established the configuration preferences or a child of the user), or one or more specified user devices (e.g., mobile devices) to which the configuration preferences are to be applied (e.g., the user's mobile phone and tablet). The configuration preferences may be stored by the server(s) 102 to the data stores 118. The configuration preferences may also be stored locally at the user device via which the configuration preferences have been established or the user device(s) to which the configuration preferences are to be applied.

The server(s) 102 may support requests to select configuration preferences including one or more information sources. For example, a plurality of information sources may be offered from which one or more information sources may be selected. A graphical user interface may be provided via a device such as a mobile device according to the configuration preferences, enabling a user of the device to access content items that have been generated or provided by the selected information sources.

Similarly, the server(s) may support requests to select configuration preferences including one or more content item(s) offered by a selected information source. For example, a plurality of content items may be offered in association with an information source, enabling one or more content items to be selected for that information source. A graphical user interface may be provided via a device such as a mobile device according to the configuration preferences, enabling a user of the device to access the selected content items provided via the selected information sources.

In some embodiments, users of the web site may access an online content store via the server(s) 102 to add information source(s) and/or content item(s) to the configuration preferences. More particularly, the store may enable the users to select information sources such as television channels, web sites, etc. In addition, the store may enable the users to select content items such as shows offered by the selected information sources. Each of the information sources and/or content items may be offered to users with no fee or with a specified subscription fee.

As shown in this example, the server(s) 102 may enable a first individual 112 to establish a first set of configuration preferences via the Internet 104 from a computer 106. The first set of configuration preferences may be associated with the first individual 112, enabling the first set of configuration preferences to be applied to one or more mobile devices owned or used by the first individual 112. Similarly, the server(s) 102 may enable a second individual 114 to establish a second set of configuration preferences via the Internet from a mobile computing device 108 such as a tablet, laptop, or smart phone, as shown. The second set of configuration preferences may be associated with the second individual 114 or the mobile computing device 108.

The consumption of the content items may be tracked via the user device and/or server(s) 102. More particularly, the user device (e.g., mobile device) may be configured to dynamically gather information with respect to content items that are consumed. This information may be similar to that recorded when users access content provided on a web site via the server(s) 102. More particularly, the information that is gathered via the user device may identify information source(s) and/or content item(s), indicate one or more characteristics of information source(s) and/or content item(s) being consumed, user data pertaining to the individual (e.g., user identifier), and/or other information (e.g., pertaining to interactions of third individual with information source(s), interactions of the individual with content item(s), and/or pertaining to circumstances surrounding the consumption of the content item(s)). For example, the information may indicate a number of times and/or period of time that the information source(s) and/or content item(s) have been accessed. Similarly, the information may indicate those information source(s) and/or content item(s) that have not been selected or consumed, or consumed for less than a threshold period of time. The device 110 may send this information to the server(s) 102, which may store this information to the data stores 118. Accordingly, user interactions with the user device or graphical user interface provided thereon may be tracked and recorded to further personalize the user experience.

The server(s) 102 may gather information pertaining to the information sources and/or content items being accessed (e.g., consumed) via the device (e.g., via the graphical user interface). This information may be received from the device and/or obtained as a result of analysis of the information received from the device. In some implementations, the information that is gathered via the server(s) 102 may identify the information source(s) and/or content item(s), indicate one or more characteristics of the information source(s) and/or content item(s) that are accessed, user data (e.g., user identifier), and/or other information (e.g., pertaining to interactions of the individual with information sources, interactions of the individual with content items and/or circumstances surrounding the consumption of the content items). For example, the information may indicate a number of times and/or period of time that the information source(s) and/or content item(s) have been accessed. Similarly, the information may indicate those information source(s) and/or content item(s) that have not been selected or consumed, or consumed for less than a threshold period of time. The server(s) may store this information to the data stores 118, enabling this information to be used to further customize the user experience. A description of the information that may be stored in the data stores 118 will be described in further detail below.

The characteristics of a content item may indicate information such as a primary subject or topic of the content item, one or more key words, results of analysis of the content item, one or more content categories indicating subject matter to which the content item relates (e.g., family, fear, comedy, drama), an identifier of the content item (e.g., URL, title, date, and/or information source), the content item or a portion thereof, and/or one or more individuals associated with the content item (e.g., author, actor(s), producer, director).

The characteristics of an information source may indicate information such as one or more content categories to which the information source relates. Such content categories may include, for example, sports, comedy, children, nature, animals, news, crime, science fiction, etc. For example, the characteristics may indicate that an information source pertains to sports where the information source is a sports channel.

As will be described in further detail below, the server(s) 102 may obtain, collect, generate, or otherwise receive information that pertains to information sources and/or content items that are accessed via the Internet, such as via the web site or via a graphical user interface of a user device such as a mobile device. This information may be stored to the data stores 118, enabling content to be personalized for an individual (or a group of individuals) based, at least in part, upon one or more of the characteristics of the information sources, one or more characteristics of the content items, and/or a user profile of the individual (or group). For example, the user profile may indicate interactions of the individual with the information source(s) and/or content item(s) (e.g., number of clicks, number of times accessing a particular information source or content item, amount of time spent accessing the particular information source or content item, and/or circumstances surrounding the consumption of the information source or content item). Information that may be maintained in a user profile will be described in further detail below.

Personalization of the user experience may include personalizing information sources and/or content items. Similarly, the personalization may include providing recommendations for information sources and/or content items. Such personalization may be performed by the web site (e.g., when the user accesses the web site) via the server(s) 102 or via other mechanisms such as electronic mail message, text message, or other suitable medium.

In some implementations, information source(s) and/or content item(s) may be recommended when the user accesses an online content store. In other implementations, such a recommendation may be provided by altering the graphical user interface presented to the user via the user device (e.g., mobile device). The recommendation may indicate a particular order or placement of the recommended information source(s) and/or content item(s) within the graphical user interface (e.g., within the context of the user's pre-existing configuration preferences). For example, the recommended information source(s) and/or content item(s) may be highlighted using one or more display characteristics such as a different color, brightness, or text characteristics. The user may choose to accept the recommendation(s) or reject the recommendation(s).

Where a content item is accessed via the Internet (e.g., via the web site), the server(s) 102 may gather information indicating one or more characteristics of the content item (e.g., URL), user data (e.g., user identifier), and/or other information (e.g., pertaining to interactions of the individual with the content item and/or pertaining to circumstances surrounding the consumption of the content item). For example the information that is gathered may pertain to one or more content items within a collection of content. The server(s) may obtain a set of characteristics of the particular content item via a variety of mechanisms, which may include analysis of text and/or image(s) within the particular content item. In addition, the server(s) 102 may obtain a set of tags associated with the particular content item.

In some embodiments, where a content item is consumed via a graphical user interface of a mobile device such as that described herein, the device may gather information indicating one or more characteristics of the information source and/or content item, user data (e.g., user identifier), and/or other information (e.g., pertaining to interactions of the individual with the content item and/or pertaining to circumstances surrounding the consumption of the content item). The characteristics of a particular content item may include, but are not limited to, a title of the content item or other identifying information (e.g., date), one or more categories (e.g., family, fear, comedy, drama), an information source from which the content item was obtained, key word(s), one or more individuals (e.g., actor, director, producer, author), and/or analysis of text and/or image(s) within or associated with the content item. The device may send the gathered information to the server(s).

In addition, the information sent by the device to the server(s) 102 may include the content item or a portion thereof. The server(s) 102 may then process the content item or the portion thereof to gather further information, as described herein.

In some embodiments, the server(s) may compare at least a portion of the information for a particular content item to information in its data store(s) 118 (or available from other web sites) in an attempt to look up information pertaining to the content item. For example, where the content item is a show, the server(s) may look up the title and information source to identify the actor(s) in the show or a category (e.g., family, fear, comedy, drama) associated with the show. However, the server(s) may be unable to accurately or easily obtain information pertaining to the content.

In some instances, the server(s) 102 may communicate with a Publisher (not shown to simplify illustration) to obtain information pertaining to the content item such as a set of characteristics of a particular content item. In some embodiments, the server(s) 102 may access a web site or data store of the Publisher to obtain the information pertaining to the content item. In other embodiments, the server(s) may transmit information pertaining to the content item to the Publisher (e.g., by transmitting the information via the Internet 104 to a server of the Publisher). For example, the information transmitted to the Publisher may include an identifier or a title of the content item and identity of the information source. The server of the Publisher may look up at least a portion of this information in its own data store(s) to identify a set of characteristics associated with the content item. The Publisher may then return information indicating one or more characteristics of the content item to the server(s) 102 associated with the web site. The Publisher may also transmit the content item to the server(s) 102, which may be analyzed by the server(s).

Any information obtained by the server(s) 102, including information (or content) received from a device such as a mobile device and/or received from Publishers may be stored, maintained, and updated in the data stores 118 such that the information is associated with the user. Information that is stored, maintained, and updated in the data stores 118 will be described in further detail below.

Data Stores

The data stores 118 may store content or references to content, which may include content items, hypertext links via which content items may be accessed, and/or URLs via which content items may be accessed. The content may be indexed for efficient retrieval.

In addition, the data stores 118 may store information such as the characteristics of information sources and/or characteristics of the content, which may be stored in association with the content. More particularly, the content may be a collection of content or a specific content item, which may be one of a plurality of content items within a collection of content. For example, the characteristics of a content item may indicate information such as an a title or other identifier of the content item, date, a primary subject or topic of the content item, one or more key words, results of analysis of the content item, one or more categories indicating subject matter to which the content item relates (e.g., fear, drama, family, comedy), and/or one or more individuals associated with the content item (e.g., author, actor(s), producer, director). Similarly, the characteristics of an information source may indicate one or more content categories to which the information source relates.

Content and/or characteristics of content within a repository of media or multimedia within the data stores 118 may be annotated. Examples of content may include text, images, audio, video, or the like, which may be processed or stored in memory. The term “annotation,” as used herein, refers to descriptive or contextual content related to a content item, for example, collected from a web site and stored in association with the web site or the content item. Annotations may include various fields of descriptive content, such as a rating of a content item, circumstances or context pertaining to the consumption of a content item, a list of keywords or categories associated with a content item, etc.

In some embodiments, as an individual interacts with a software application or a device such as a mobile device, descriptive content such as, for example, a date and/or time, may be identified and stored in the data stores 118 such that the descriptive content is stored in association with content. Descriptive content may also be stored along with contextual content. For example, how content came to be identified (e.g., it was contained in a web page or was accessed via a mobile device) may be stored in the data stores 118 as contextual content associated with the content. Contextual content, therefore, may identify circumstances surrounding retrieval or consumption of content (e.g., date or time a content item was received or consumed and/or a source of the content item) and may be associated with descriptive content in the data stores 118. Contextual content, may, for example, be used to subsequently search for associated descriptive content. For example, a search for content items that have been retrieved from a particular web site or consumed under specific circumstances may be identified.

In addition, the data stores 118 may include account information (e.g., data) for a plurality of user accounts. Therefore, account information pertaining to user accounts may be retained in one or more memories that are coupled to the server 102.

Account information may include financial information such as credit card information, enabling goods or services provided in association with the account to be purchased. In addition, the account information may include information pertaining to goods or services available to the user via the user account or used by the user. More particularly, the account information may indicate an amount and/or quality of the goods or services available to the user or used by the user. In addition, the account information may indicate a cost associated with the amount and/or quality of goods or services available to the user or used by the user.

The account information may also include or be linked to additional information pertaining to the user. For example, the server(s) 102 may have access to additional user information, which may be retained in one or more user logs stored in the data stores 118. This user information or a portion thereof may be referred to as a user profile. More particularly, the user profile may include public information that is available in a public profile and/or private information. Furthermore, the user profile may include information that has been submitted by the user and/or information that has been deduced or automatically collected by the system (e.g., based upon user action(s)). For example, the user profile may indicate a configuration of a graphical user interface, which may indicate configuration preferences established by the user, a default configuration, and/or configuration recommendations provided by the system. In addition, the user profile may be periodically updated as an individual consumes (e.g., views) content provided via a web site or via a graphical user interface such as that described herein while using a device such as a mobile device.

A profile builder may initiate generation of a profile, such as for users of an application, including a search engine or messaging application, for example. A profile builder may initiate generation of a user profile for use, for example, by a user, as well as by an entity that may have provided the application. For example, a profile builder may enhance relevance determinations and thereby assist in indexing, searching or ranking search results, as well as assist in the identification of further content to be provided via various media. Therefore, a provider such as a search engine provider may employ a profile builder.

A variety of mechanisms may be implemented to generate and/or update a profile including, but not limited to, collecting or mining navigation history, stored documents, tags, or annotations, to provide a few examples. In addition, the profile may be updated with information gathered as a result of the use of a device such as a mobile device. A profile builder may store a generated or updated profile.

Through the use of user profiles, for example, a web site such as a search engine provider may retrieve annotations, tags, stored pages, navigation history, or the like, which may be useful for making relevance determinations of search results. In addition, further content to be provided or recommended via a device such as a mobile device may be identified using the user profiles.

The user information retained in the user logs 118 may include personal information such as demographic information and/or geographic information. Examples of demographic information include age and gender. Examples of geographic information include residence address, work address, and/or zip code.

Each time an individual performs online activities such as clicking on a content item (e.g., an advertisement or media item), purchasing goods or services, sending messages, retrieving messages, accessing a media item, posting information or content, or annotating content, information regarding such activity or activities may be retained as user data in the user logs 118. For instance, the user data that is retained in the user logs 118 may indicate the identity of web sites visited, identity of content items (e.g., URLs or advertisements) and/or information sources that have been selected (e.g., clicked on) via the web site or a graphical user interface, and/or a timestamp indicating a date and/or time that the individual viewed or accessed the content item. Moreover, information associated with a search query, such as search term(s) of the search query, information indicating characteristics of search results that have been selected (e.g., clicked on) by the individual, and/or associated timestamp may also be retained in the user logs 118. Thus, the information may indicate whether the individual clicked on or viewed a content item (or information source) and, if so, the number of clicks or views within a particular time period and/or amount of time the content item (or information source) was accessed by the individual. An individual may be identified in the user logs 118 by a user ID (e.g., user account ID), information in a user cookie, Internet Protocol (IP) address, etc.

An enormous amount of information may be collected via web sites based upon various interactions (or lack thereof) of individuals with the digital media items provided via the web sites. For example, the web sites may ascertain whether the individuals access particular media items, which may or may not have been recommended by the web sites. As another example, the web sites may record a number of clicks by individuals to various media items. Using the collected information, the web sites may personalize the experience of the individuals accessing the media items.

In some embodiments, each time a user consumes content while using a mobile device or graphical user interface such as that described herein, information regarding such activity may be retained as user data in the user logs 118. More particularly, where a user consumes a content item such as a video while using the device, the user logs 118 may be updated such that the information is associated with the user, where the information indicates: one or more characteristics of the content item, a date and/or time that the content item was consumed, information pertaining to interactions of the individual with the content item (e.g., an amount of time spent by the individual consuming the content item or number of times the content item was accessed), information pertaining to circumstances surrounding the consumption of the content item (e.g., weather, day of the week, time of year, etc.), and/or a user identifier. The characteristics of the content item may indicate information such as a title or other identifier of the content item, a date, one or more content categories indicating subject matter to which the content relates, a primary subject or topic of the content, one or more key words, one or more individuals associated with the content item (e.g., author, actor, producer, director), and/or other results of analysis of the content item.

While at least a portion of the information (e.g., an amount of time spent by the user consuming a particular content item) may be stored in the user logs 118, information such as the characteristics of the content item may be stored in association with the content item. For example, a record in the data store(s) 118 may include information pertaining to a content item. In addition, the record pertaining to the content item may be associated with another record including information pertaining to an information source from which the content item originated. For example, the record pertaining to the information source may indicate characteristics of the information source.

The information pertaining to the content item and/or information source may be associated with each of the users that have consumed (e.g., viewed) the particular content item (e.g., while using a mobile device) by linking the record(s) or information to the user profile of each of the users that have consumed the content item. For example, the user profile of each of the users that have consumed the content item may include a pointer to the record(s) or the information.

The user logs 118 may further indicate whether the content item has been accessed via the web site or from a mobile device. The user logs 118 may further identify a specific mobile device (e.g., IP address) where the content item has been accessed via a mobile device. This indication may be used to make a variety of determinations, such as preferences of the user with respect to device(s), information source(s), content item(s), and/or circumstances (e.g., times, days). For example, the system may determine that the user prefers to view a particular show via a mobile device rather than a desktop computer. Accordingly, the indication or determinations may be used to further personalize content or recommendations.

Based upon the information recorded in user profiles of individuals, a machine learning algorithm may learn how to identify characteristics of information sources and/or content items that may be of interest to individuals (or a similarly situated group of individuals) in the future. In some embodiments, a machine learning algorithm may be implemented to identify information sources and/or content items that may be of interest to the user. Such a machine learning algorithm may also assist in identifying an appropriate placement of a content item (or information source) within a web page or graphical user interface prior to the generation of the web page or the graphical user interface.

### Example Embodiments

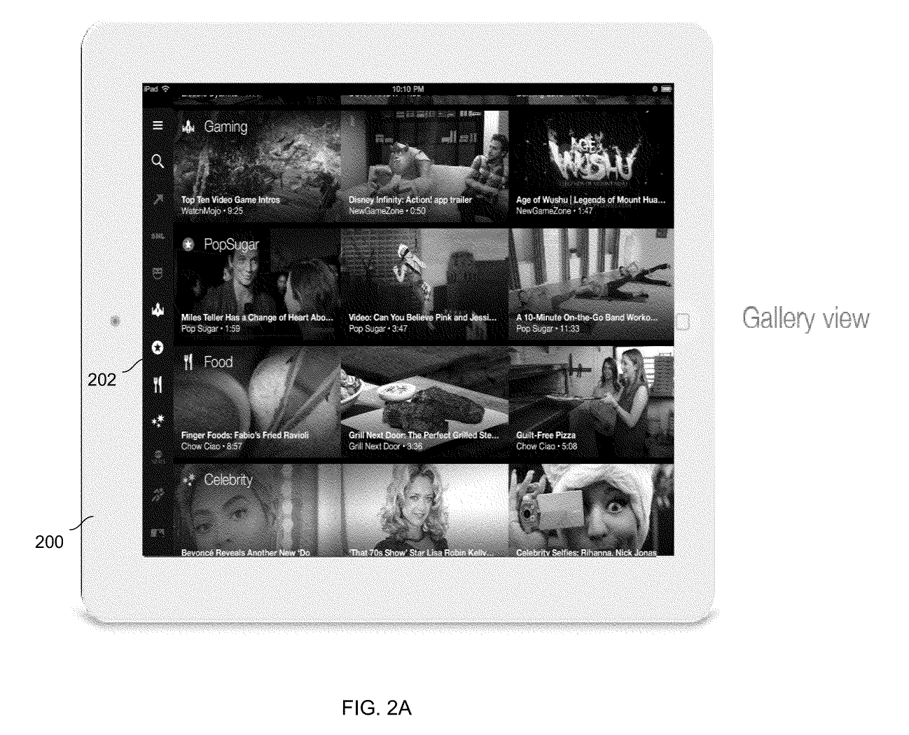

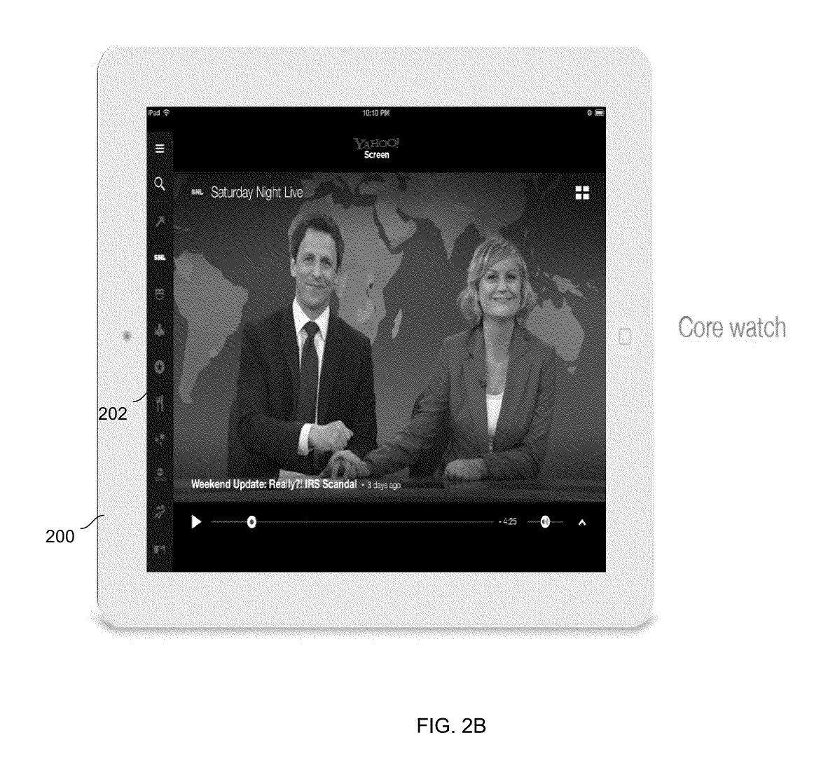

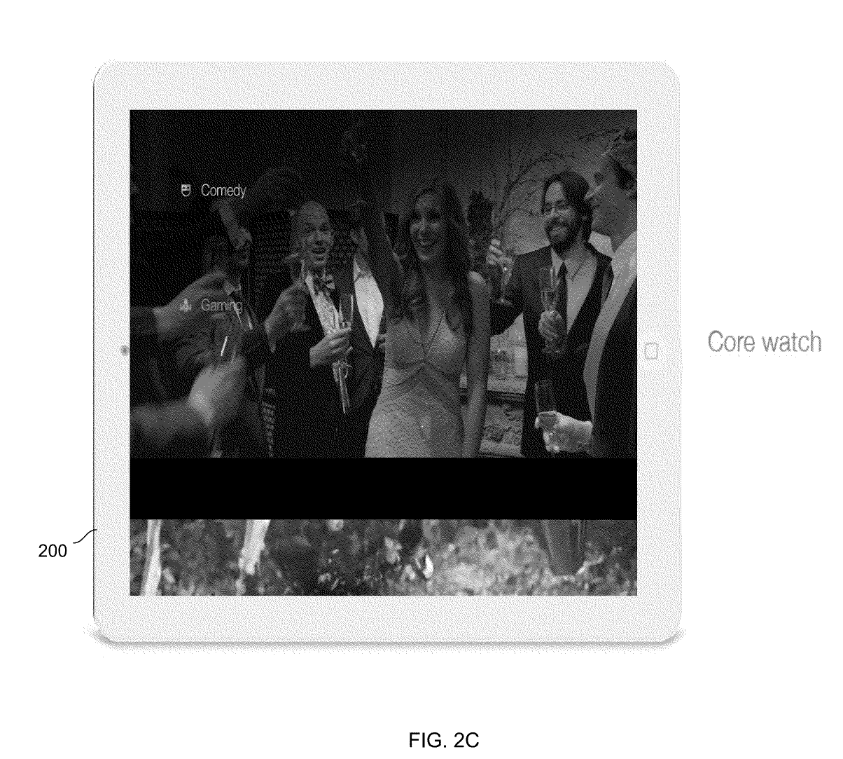

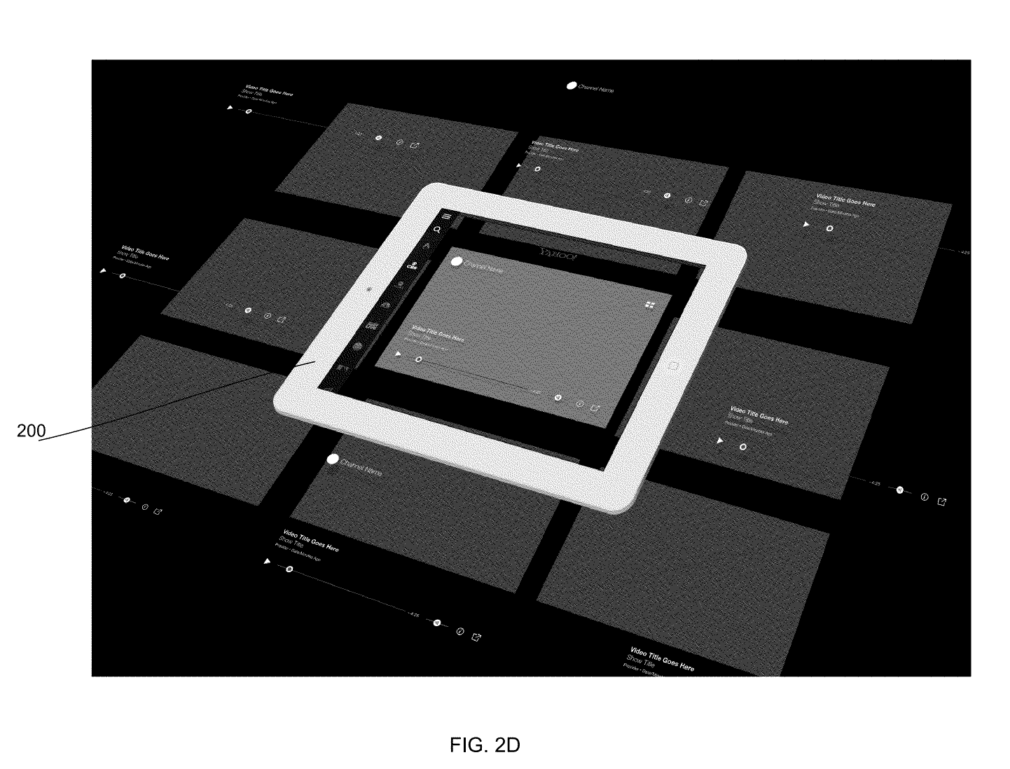

FIG. 2A is an example graphical user interface providing a gallery view in accordance with various embodiments. As shown in this example, the graphical user interface of a device such as a mobile device 200 may include a plurality of rows, where each row corresponds to a different one of a plurality of information sources. Each of the information sources may also be referred to as a channel. Each row may include a plurality of icons, where each one of the plurality of icons corresponds to a different one of a plurality of content items offered by that information source. In this example, four different rows represent four different information sources.

In accordance with various embodiments, the graphical user interface may be presented in the form of a grid. This grid may be a subset of a larger grid representing a “world view” of all information sources and content items available to the user. In other words, the rows in the graphical user interface may be a subset of rows in the larger grid. Similarly, the icons within any given row in the graphical user interface may be a subset of icons within that row in the larger grid. Each of the plurality of icons may be represented in the form of a square or rectangular segment within the grid.

The use of a grid format to organize information sources and corresponding content items may provide a user with a conceptual map of how content items such as videos are laid out. This provides an intuitive framework, enabling the user to zoom in to access a particular channel (or content item) or zoom out to simultaneously access a greater number of content items within the graphical user interface.

In one embodiment, each of the information sources corresponds to a different source of videos. For example, at least a subset of the rows may correspond to television channels, where the icons in those rows represent shows or episodes of shows. However, it is important to note that each row need not correspond to the same type of information source. More particularly, while at least a subset of the rows may correspond to television channels, the remaining rows need not correspond to television channels. For example, one or more rows may correspond to web sites such as Flickr. In addition, each row need not correspond to the same type of content. For example, a subset of the rows may correspond to photos, while a second subset of the rows may correspond to videos.

Where an information source corresponds to a television channel, each content item may correspond to a show or an episode of a show. More particularly, the content item may include a video or video clip. For example, a video may include a show, while a video clip may include a portion of a show such a sound byte or scene. A content item may be identified by a title of the show, and may be further identified by a title of a particular episode of the show. For example, an icon representing the content item may include one or more titles such as a title of a show and/or specific episode. In addition, the channel may be identified in association with each of the rows. For example, the icon of a content item may identify the channel offering the content item. As another example, the first icon within a given row may identify the channel associated with that row.

In accordance with various embodiments, a user may scan and browse content associated with information sources much like the familiar way in which they browse television content. More particularly, the user may perform a gesture such as a vertical (e.g., upward or downward) swiping gesture to navigate (e.g., scroll) among the rows corresponding to various different information sources. In this example, four different rows corresponding to four different information sources are illustrated. However, the configuration may include any number of information sources. Where the configuration includes more information sources and therefore more rows than can be presented at the same time via the display, the user can perform a vertical swiping gesture to scroll among the rows of icons within a larger grid. In this manner, a user may flip between channels of content.

In addition, a channel icon 202 may operate similarly to a remote control to enable the user to select or navigate (e.g., scroll) among a plurality of different information sources (i.e., channels). More particularly, the channel icon 202 may be a vertical channel strip that enables a user to easily switch channels from a plurality of different channels, where each of the plurality of different channels is represented at a different location or segment of the vertical channel strip. The user may submit input with respect to the channel icon 202, where the input indicates a direction of navigation with respect to the plurality of rows. For example, the user may click or swipe the channel icon 202 to navigate among the plurality of channels. As the user swipes or otherwise interacts with the channel icon 202, the channel may be automatically changed. In addition, as the channel is changed, the content item (e.g., video) that is rendered via the device may also be automatically changed. For example, the first content item (e.g., video) for that row may be provided. As another example, where a content item in that channel was previously being consumed, rendering of the content item may resume at a point at which the user previously stopped or paused the content item (e.g., video).

In this example, the vertical channel strip is a rectangular region displayed along the left side of the rows of icons, where the rectangular region extends substantially along the height of the display. Although the channel icon 202 is shown at the left side of the display in this example, this example is merely illustrative. Thus, the channel icon 202 may be presented in a different position. In addition, the channel icon 202 need not be displayed within the graphical user interface to enable the user to change channels using a gesture such as a swiping gesture.

In addition, the user may perform a gesture such as a swiping or tapping gesture to navigate (e.g., scroll) among the different content items for a given information source. For example, the user may perform a horizontal (e.g., left or right) swiping gesture to navigate the graphical user interface to access the content items represented within the graphical user interface. Although the rows in this example may appear to include the same number of icons, each row need not include the same number of icons. In addition, the number content items for a given information source may be greater than the number of content items that can be represented simultaneously within a row of the display. Therefore, the user may perform a horizontal swiping gesture to navigate (e.g., scroll) within the larger grid to view further content items (e.g., videos) for those information sources (and corresponding rows) that are represented in the graphical user interface.

In some embodiments, as the user navigates among the rows and/or icons within a row, a content item may be automatically rendered. In other embodiments, the rendering of a content item may be triggered via a gesture or other input of the user, such as a single or double tap on the icon representing the content item.

The user may also choose to zoom in or out on a particular content item. This may be accomplished, for example, by performing a pinching or spreading gesture with respect to the corresponding icon rendered in the graphical user interface.

The graphical user interface of the device 200 may render a content item after selection of the content item or after zooming in on the content item. FIG. 2B is an example graphical user interface providing a core watch view of a single content item in accordance with various embodiments. In the core watch view, the content item may be rendered in substantially the entire display area of a display of the device. As shown in this example, the channel icon 202 or vertical channel strip may continue to be displayed after or while a content item is being rendered via the user device. At any time, the user may choose to interact with the vertical channel strip (e.g., channel icon), which may enable the user to change channels or access the gallery view shown in FIG. 2A.

FIG. 2C is an example graphical user interface providing a full screen view of a single content item in accordance with various embodiments. The user may choose to view a full screen view, which results in the content item being rendered in substantially the entire area of a display of the device without rendering the channel icon. The full screen view may provide an overlay indicating a position of the content item and associated channel with respect to other rows and corresponding channels within the grid. As shown in this example, the overlay includes a Comedy icon and a Gaming icon, indicating that the content item is from the Comedy channel, which is adjacent to the Gaming channel within the grid. The user may select the full screen view by zooming in on the content item or by performing a gesture such as a single or double tap on the content item. In some embodiments, the full screen view may be provided automatically after the content item has been rendered for a threshold period of time.

FIG. 2D is a diagram illustrating a single content item rendered within the context of a grid in accordance with various embodiments. As shown in this example, even when a single content item is rendered in the graphical user interface via a display of the device 200, the single content item continues to exist within the context of the larger grid. Other segments of the grid may become visible to the user when the user zooms out. The user may choose to access other rows or content items within the grid, as described herein.

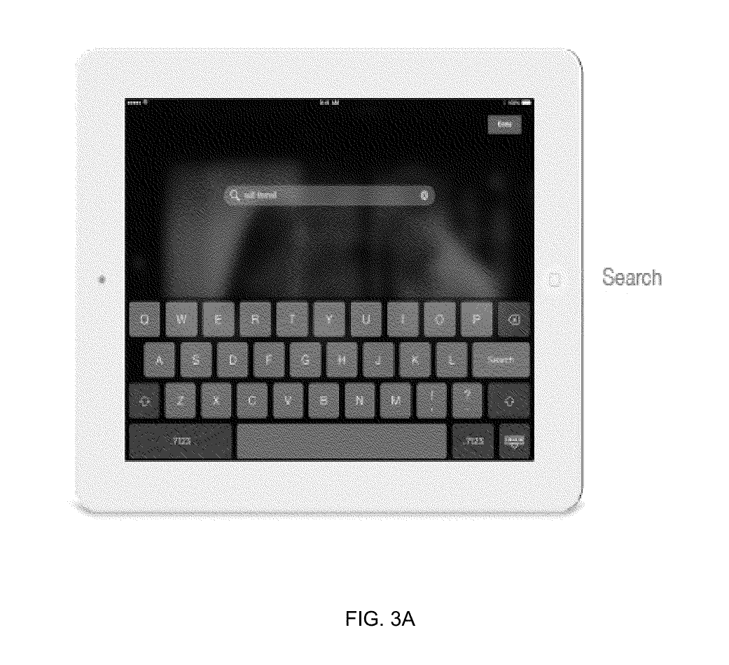

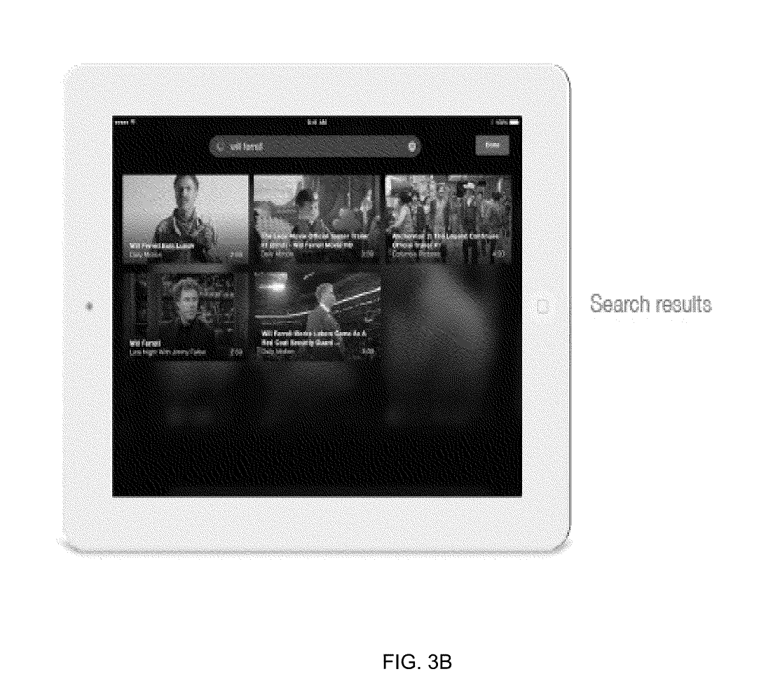

FIG. 3A is an example graphical user interface for receiving search queries in accordance with various embodiments. As shown in FIG. 3A, a user may submit a search query to access content items of interest. In this example, the user enters “Will Ferrell” to find videos that include Will Ferrell.

FIG. 3B is an example graphical user interface that may enable a user to navigate among search results in accordance with various embodiments. In response to the user's search query, a plurality of content items satisfying the user's query are returned. In this example, five different videos have been returned, where each of the videos is represented by a corresponding icon.

In order to navigate among the videos, the user may perform one or more swiping gestures, as described above. More particularly, the user may perform a vertical swiping gesture to navigate upward or downward among the different rows of icons. The user may also perform a horizontal swiping gesture to navigate left or right among the icons within a given row of icons.

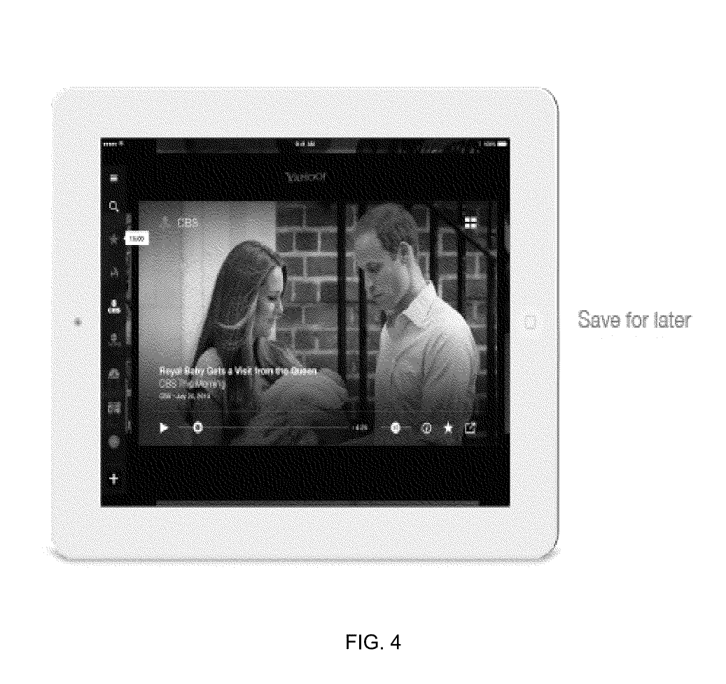

FIG. 4 is an example graphical user interface that may be used to save a content item in accordance with various embodiments. After the user has selected a content item or started viewing the content item, the user may choose to save the content item for later. In some embodiments, this may be accomplished by adding the saved content item to a saved content queue. The saved content queue may be implemented in the form of a saved content channel. Thus, the saved content items may be made available to the user via a corresponding row of the graphical user interface. The saved content channel may be accessed via the channel icon, as well as gestures such as vertical swiping gestures as described herein.

The graphical user interface that is rendered via the user device may be generated based, at least in part, upon a configuration indicating a set of information sources and/or content items to be represented via a display of the user device. The configuration may be a default configuration. In some embodiments, the configuration may be user-specified. More particularly, the information sources and/or content items may be configured.

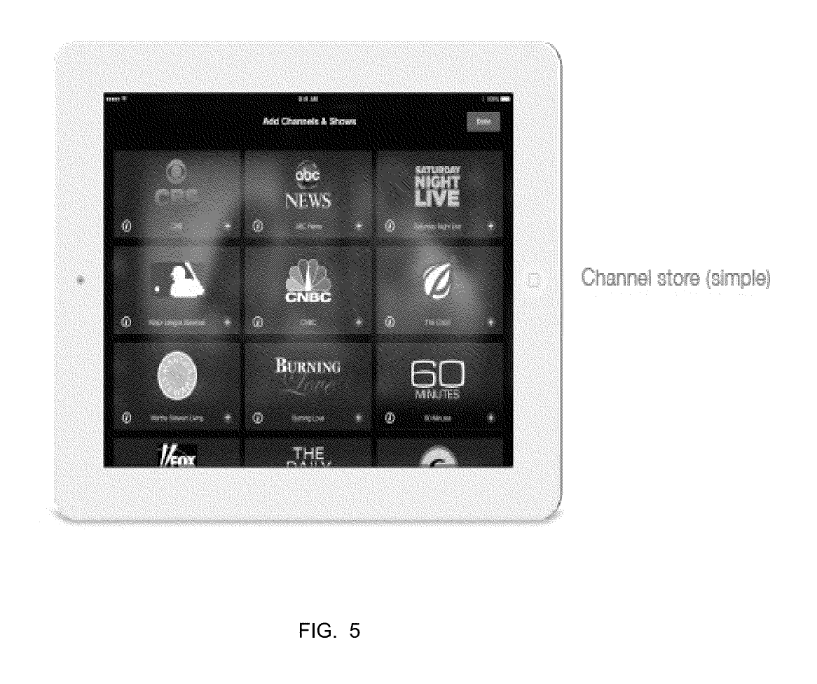

FIG. 5 is an example online content store via which the graphical user interface can be configured in accordance with various embodiments. Through the online content store, a user may select or purchase one or more channels from a plurality of channels. Upon selecting or purchasing a particular channel via the online content store, a row including a plurality of icons representing content items (e.g., all content items) offered by that channel may be rendered via the graphical user interface presented via device such as a mobile device.

In some embodiments, for a given channel, a user may select or purchase one or more content items (e.g., shows) from a plurality of content items. In this example, channels available for selection or purchase are represented as rows (e.g., in a grid), while shows available for selection or purchase for a given channel are represented as icons within the corresponding row (e.g., as sections within the grid presented via the online channel store). The user may click on a desired show or corresponding section of the grid presented via the online content store. More particularly, by selecting a channel via the online content store, a corresponding row may be presented via the graphical user interface. Within the row, shows that may be accessed for that channel may be represented by corresponding icons. If the user selects specific show(s) for the selected channel, the icons displayed within the row may correspond solely to the selected shows.

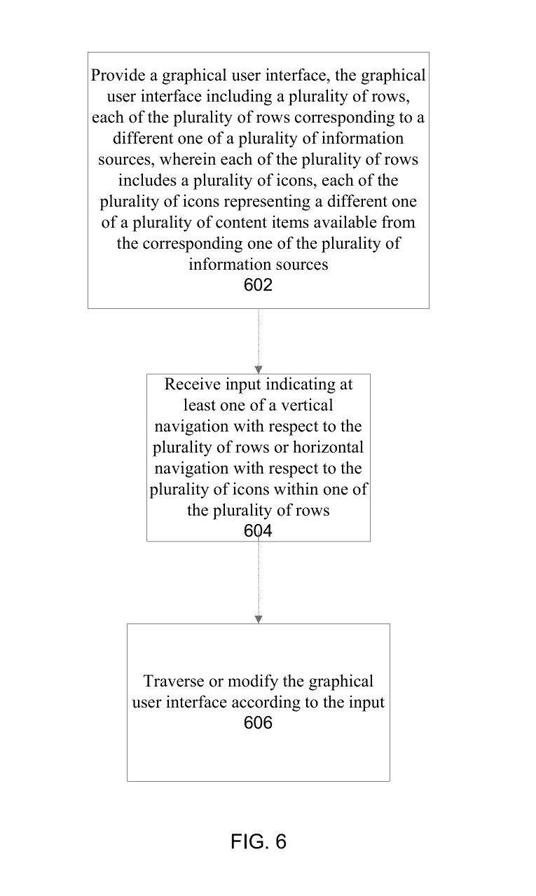

FIG. 6 is a process flow diagram illustrating an example method of navigating a graphical user interface in accordance with various embodiments. A graphical user interface may be provided at 602. More particularly, the graphical user interface may be rendered via a display of a user device such as a mobile device. The graphical user interface may include a plurality of rows, where each of the plurality of rows corresponds to a different one of a plurality of information sources. Each of the plurality of rows may include a plurality of icons, where each of the plurality of icons represents a different one of a plurality of content items available from the corresponding one of the plurality of information sources.

Input may be received at 604 via the user device, where the input indicates at least one of a vertical navigation with respect to the plurality of rows or horizontal navigation with respect to the plurality of icons within one of the plurality of rows. More particularly, the input may include a gesture such as a swiping or tapping gesture. In some instances, the input may be received with respect to a channel icon, as described herein.

The graphical user interface may be traversed or modified according to the input at 606. More particularly, traversal of the graphical user interface may result in the movement of a cursor or other indicator within the context of the graphical user interface. For example, the cursor or other indicator may traverse vertically among the plurality of rows, thereby indicating one of the plurality of rows that is currently selected by a user. Similarly, a cursor or other indicator may traverse horizontally among the plurality of icons within one of the plurality of rows, thereby indicating one of the plurality of icons and corresponding content item that is currently selected by the user.

In some embodiments, the traversal of the graphical user interface may be accomplished by traversing a grid including the plurality of rows such that a subset of the grid (e.g., a subset of icons in the grid) is represented in the graphical user interface. More particularly, the row(s) displayed in the graphical user interface may be a subset of rows within the grid. Similarly, the icon(s) (or corresponding content item) displayed in the graphical user interface for a given row may be (or correspond to) a subset of icons in that row within the grid.

The graphical user interface may be modified as the user “scrolls” vertically among the rows of the grid, resulting in the display of one or more further row(s) and/or elimination of the display of one or more previously displayed rows within the graphical user interface. Stated another way, the plurality of information sources for which the plurality of rows are displayed in the graphical user interface may change as the user continues to scroll upward or downward. Similarly, the graphical user interface may be modified as the user “scrolls” horizontally among the icons within one of the rows of the larger grid, resulting in the display of one or more further icon(s) for row(s) that are displayed and/or elimination of the display of one or more of the previously displayed icon(s) for those row(s). In other words, the plurality of icons displayed for a given row in the graphical user interface may change as the user continues to scroll left or right.

In addition, one of the plurality of content items represented by one of the plurality of icons within one of the plurality of rows may be provided in accordance with the input. More particularly, a content item may be rendered automatically in response to the vertical or horizontal navigation within the graphical user interface. Alternatively, a content item may be rendered after the user specifically selects a content item (e.g., by tapping or double-tapping on the content item).

As described above, a user may perform a vertical swiping gesture to navigate (e.g., scroll) with respect to a plurality of rows and corresponding information sources (i.e., channels). For example, a user may perform an upward or downward swipe along a vertical axis of the display to change channels. Accordingly, as the user swipes along the display in a vertical direction, the information source from which a content item is provided by the device may automatically change.

In some embodiments, the user may submit input such as a swiping or tapping action with respect to a channel icon such as a vertical channel strip to navigate among the plurality of rows and corresponding information sources. For example, the user may tap the channel icon or perform a vertical swiping action along the channel icon to change the channel.

Once the user has found an information source (e.g., channel) that they like, the user may easily navigate among the content items offered by that channel. This may be accomplished by performing a horizontal swiping gesture to navigate among the icons within a particular row. More particularly, as the user swipes across the display either left or right along a horizontal axis, the content item that is rendered via the device may automatically change. As a result, a clicking action need not be performed by the user in order to change the content item being provided via the device. Alternatively, in some embodiments, to select one of the plurality of content items in a given row, the user may perform a single or double click action on one of the plurality of icons.

Personalization

The identity of the user of the device may be ascertained via a variety of mechanisms. In some embodiments, an identity of the user (e.g., owner) of the device may be statically configured. Thus, the device may be keyed to an owner or multiple owners. In other embodiments, the device may automatically determine the identity of the user (e.g, wearer) of the device. For instance, a user of the device may be identified by deoxyribonucleic acid (DNA), retina scan, and/or finger print.

The identity of the user of the device may be used in various embodiments in order to personalize the user experience. In some embodiments, such personalization may include tailoring the graphical user interface rendered via a display of a mobile device to the user's explicit and/or implicit preferences. The user's preferences may be established remotely and/or locally via the device. In other embodiments, personalization may be performed via the device or another device based, at least in part, upon interaction of a user with the graphical user interface rendered via the device.

In accordance with various embodiments, information pertaining to input received via the graphical user interface of the device (or lack thereof) may be gathered and transmitted by the device to the server(s). This information may also include the identity of the user. Therefore, the server(s) 102 may associate information that is gathered and/or any analysis thereof with the user, enabling content items or recommendations (e.g., of content items and/or information sources) to be personalized for the user based, at least in part, upon the gathered information.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Social Network

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so called ‘virtual persons.’ An individual's social network may be represented in a variety of forms, such as visually, electronically or functionally. For example, a “social graph” or “socio-gram” may represent an entity in a social network as a node and a relationship as an edge or a link.

Multi-Modal Communication (MMC)

Individuals within one or more social networks may interact or communicate with other members of a social network via a variety of devices. Multi-modal communication technologies refers to a set of technologies that permit interoperable communication across multiple devices or platforms, such as cellphones, smart phones, tablet computing devices, personal computers, televisions, SMS/MMS, email, instant messenger clients, forums, social networking sites (such as Facebook, Twitter, or Google), or the like.

Network Architecture

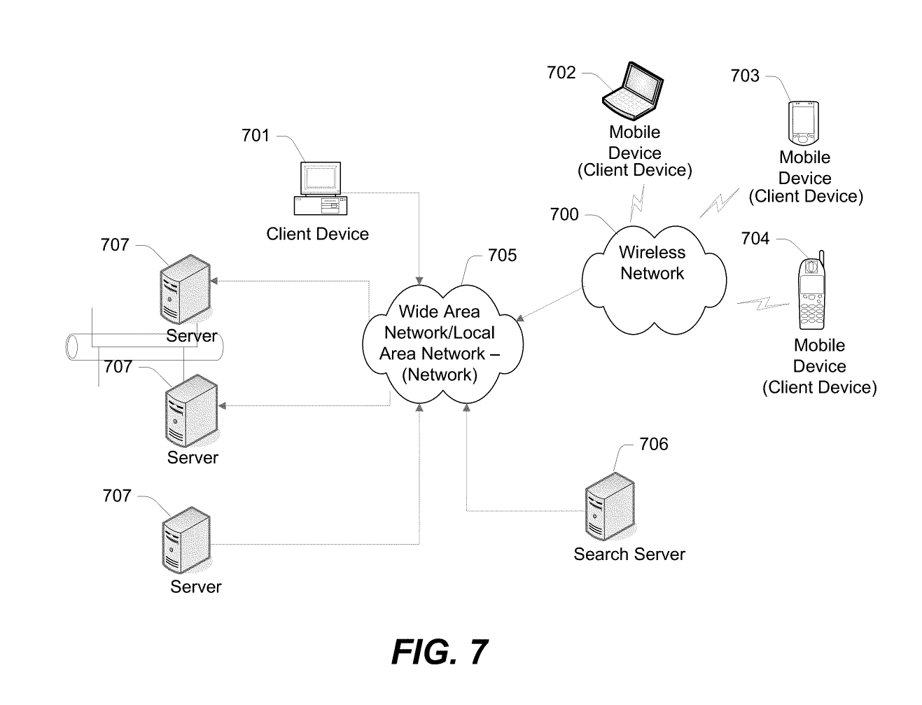

The disclosed embodiments may be implemented in any of a wide variety of computing contexts. FIG. 7 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 7, for example, includes a variety of networks, such as a LAN/WAN 705 and wireless network 700, a variety of devices, such as client devices 701-704, and a variety of servers such as content server(s) 707 and search server 706. The servers may also include an ad server (not shown). As shown in this example, the client devices 701-704 may include one or more mobile devices 702, 703, 704. Client device(s) 701-704 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The disclosed embodiments may be implemented in some centralized manner. This is represented in FIG. 7 by server(s) 707, which may correspond to multiple distributed devices and data store(s). The server(s) 707 and/or corresponding data store(s) may store user account data and other user information.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

Crawler

A crawler may be operable to communicate with a variety of content servers, typically via a network. In some embodiments, a crawler starts with a list of URLs to visit. The list may be called a seed list. As the crawler visits the URLs in the seed list, it identifies all the hyperlinks in the page and adds them to a list of URLs to visit, called the crawl frontier. URLs from the crawler frontier are recursively visited according to a set of policies. A crawler typically retrieves files by generating a copy for storage, such as local cache storage. A cache refers to a persistent storage device. A crawler may likewise follow links, such as HTTP hyperlinks, in the retrieved file to additional files and may retrieve those files by generating copy for storage, and so forth. A crawler may therefore retrieve files from a plurality of content servers as it “crawls” across a network.

Indexing

An indexer may be operable to generate an index of content, including associated contextual content, such as for one or more databases, which may be searched to locate content, including contextual content. An index may include index entries, wherein an index entry may be assigned a value referred to as a weight. An index entry may include a portion of the database. In some embodiments, an indexer may use an inverted index that stores a mapping from content to its locations in a database file, or in a document or a set of documents. A record level inverted index contains a list of references to documents for each word. A word level inverted index additionally contains the positions of each word within a document. A weight for an index entry may be assigned. For example, a weight, in one example embodiment may be assigned substantially in accordance with a difference between the number of records indexed without the index entry and the number of records indexed with the index entry.

Client Device

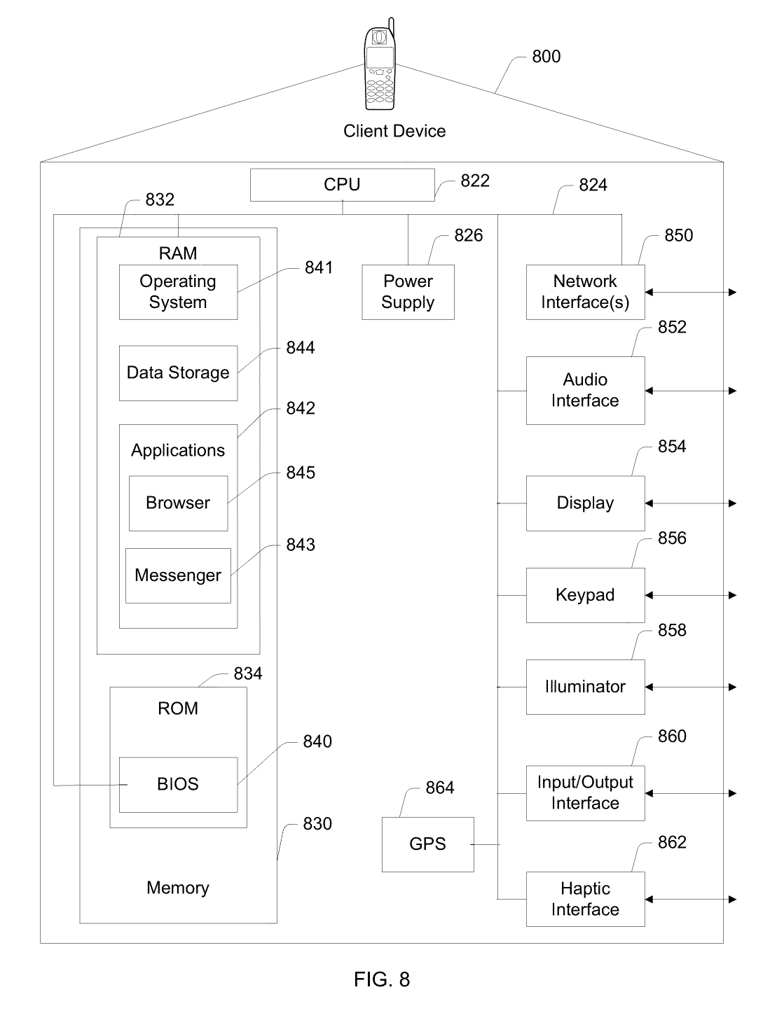

A user may access content items via a client device such as a mobile device. FIG. 8 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

In some embodiments, the device may support connection to a wireless network such as a cell phone network, localized Bluetooth™ devices, Worldwide Interoperability for Microwave Access (Wi-MAX) and/or Wireless Fidelity (Wi-Fi). In addition, the device may support other communication mechanisms such as Universal Serial Bus (USB), etc.

As shown in this example, a client device 800 may include one or more central processing units (CPUs) 822, which may be coupled via connection 824 to a power supply 826 and a memory 830. The memory 830 may include random access memory (RAM) 832 and read only memory (ROM) 834. The ROM 834 may include a basic input/output system (BIOS) 840.

The RAM 832 may include an operating system 841. More particularly, a client device may include or may execute a variety of operating systems, including a personal computer operating system, such as a Windows, iOS or Linux, or a mobile operating system, such as iOS, Android, or Windows Mobile, or the like. The client device 800 may also include or may execute a variety of possible applications 842 (shown in RAM 832), such as a client software application such as messenger 843, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 800 may also include or execute an application to communicate content, such as, for example, textual content, multimedia content, or the like, which may be stored in data storage 844. A client device may also include or execute an application such as a browser 845 to perform a variety of possible tasks, such as browsing, searching, playing various forms of content, including locally stored or streamed video, or games (such as fantasy sports leagues).

The client device 800 may send or receive signals via one or more interface(s). As shown in this example, the client device 800 may include one or more network interfaces 850. The client device 800 may include an audio interface 852. In addition, the client device 800 may include a display 854 and an illuminator 858. The client device 800 may further include an Input/Output interface 860, as well as a Haptic Interface 862 supporting tactile feedback technology.

The client device 800 may vary in terms of capabilities or features. Claimed subject matter is intended to cover a wide range of potential variations. For example, a cell phone may include a keypad such 856 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 864 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. Moreover, a system implementing various embodiments may be a portable device, such as a laptop or cell phone. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

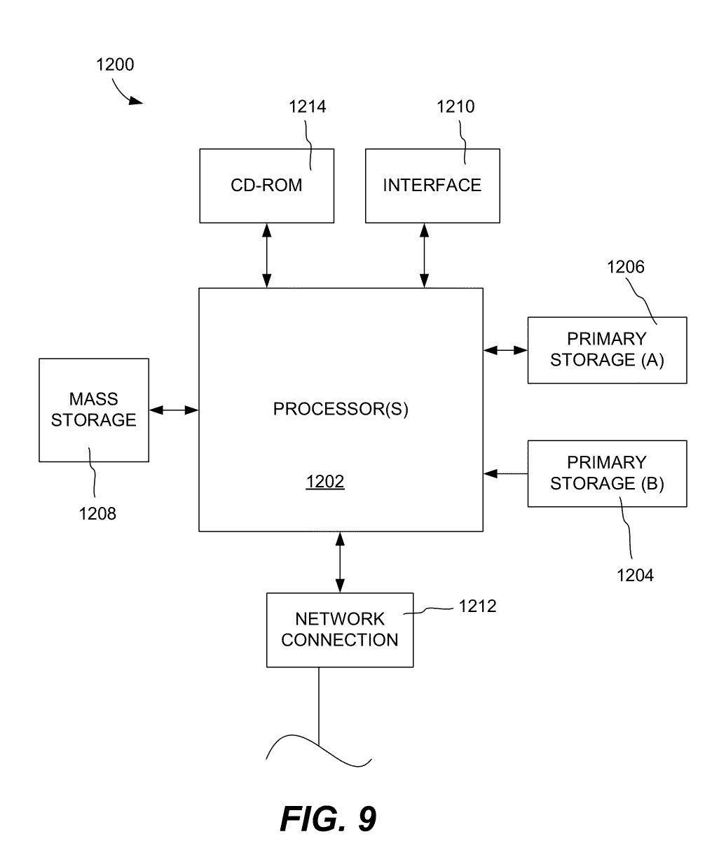

FIG. 9 illustrates a typical computer system that, when appropriately configured or designed, can serve as a system via which various embodiments may be implemented. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing embodiments have been described in some detail for purposes of clarity of understanding, it will be apparent that certain changes and modifications may be practiced within the scope of the appended claims. Therefore, the present embodiments are to be considered as illustrative and not restrictive, and are not to be limited to the details given herein, but may be modified within the scope and equivalents of the appended claims.

What is claimed is:

1. A method, comprising:
providing a graphical user interface, the graphical user interface including a plurality of rows, each of the plurality of rows corresponding to a different one of a plurality of information sources, wherein each of the plurality of rows includes a plurality of icons, each of the plurality of icons representing a different one of a plurality of content items available from the corresponding one of the plurality of information sources;
receiving input indicating at least one of a vertical navigation with respect to the plurality of rows or horizontal navigation with respect to the plurality of icons within one of the plurality of rows; and
traversing or modifying the graphical user interface according to the input.

2. The method as recited in claim 1, wherein traversing or modifying the graphical user interface comprises:
traversing a grid including the plurality of rows such that a subset of icons within the grid are represented via the graphical user interface.

3. The method as recited in claim 1, further comprising:
rendering one of the plurality of content items represented by one of the plurality of icons within one of the plurality of rows according to the input.

4. The method as recited in claim 1, wherein each of the plurality of information sources corresponds to a different source of videos.

5. The method as recited in claim 1, wherein the plurality of information sources are configurable.

6. The method as recited in claim 1, wherein the graphical user interface further comprises a channel icon, wherein the input is received with respect to the channel icon and indicates a direction of navigation among the plurality of rows.

7. The method as recited in claim 6, wherein the channel icon comprises a vertical channel strip.

8. The method as recited in claim 1, wherein the input comprises one or more swiping gestures.

9. A non-transitory computer-readable storage medium storing thereon computer-readable instructions, comprising:
instructions for providing a graphical user interface, the graphical user interface including a plurality of rows, each of the plurality of rows corresponding to a different one of a plurality of information sources, wherein each of the plurality of rows includes a plurality of icons, each of the plurality of icons representing a different one of a plurality of content items available from the corresponding one of the plurality of information sources;
instructions for receiving input indicating at least one of a vertical navigation with respect to the plurality of rows or horizontal navigation with respect to the plurality of icons within one of the plurality of rows; and
instructions for traversing or modifying the graphical user interface according to the input.

10. The non-transitory computer-readable storage medium as recited in claim 9, wherein traversing or modifying the graphical user interface comprises:
traversing a grid including the plurality of rows such that a subset of icons within the grid are represented via the graphical user interface.

11. The non-transitory computer-readable storage medium as recited in claim 9, wherein each of the plurality of information sources corresponds to a different source of videos.

12. The non-transitory computer-readable storage medium as recited in claim 9, wherein one or more of the plurality of information sources comprise web sites.

13. The non-transitory computer-readable storage medium as recited in claim 9, wherein the plurality of information sources are configurable.

14. The non-transitory computer-readable storage medium as recited in claim 9, wherein the graphical user interface further comprises a channel icon, wherein the input indicates a direction of navigation among the plurality of rows and is received with respect to the channel icon.

15. The non-transitory computer-readable storage medium as recited in claim 9, wherein the input comprises one or more swiping gestures.

16. An apparatus, comprising:
a display;
a processor; and
a memory, at least one of the processor or the memory being adapted for:
providing a graphical user interface via the display, the graphical user interface including a plurality of rows, each of the plurality of rows corresponding to a different one of a plurality of information sources, wherein each of the plurality of rows includes a plurality of icons, each of the plurality of icons representing a different one of a plurality of content items available from the corresponding one of the plurality of information sources;
receiving input indicating at least one of a vertical navigation with respect to the plurality of rows or horizontal navigation with respect to the plurality of icons within one of the plurality of rows; and
traversing or modifying the graphical user interface according to the input.

17. The apparatus as recited in claim 16, wherein the apparatus is a mobile device.

18. The apparatus as recited in claim 16, wherein the plurality of information sources are configurable.

19. The apparatus as recited in claim 9, wherein the graphical user interface further comprises a channel icon, wherein the input indicates a direction of navigation among the plurality of rows and is received with respect to the channel icon.

20. The apparatus as recited in claim 9, wherein the input comprises one or more swiping gestures.
